(19) United States
(12) Patent Application Publication
(10) Pub. No.: US 2006/0029921 A1
(43) Pub. Date: Feb. 9, 2006

(54) Personal hygiene training kit and method for pre-literate children

(76) Inventors: John Dwayne Walther, Loveland, OH (US); Matthew Aaron Neumann, Sharonville, OH (US); Jeffrey James Stechschulte, Cincinnati, OH (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 11/189,249

(22) Filed: Jul. 26, 2005

Related U.S. Application Data
(60) Provisional application No. 60/598,778, filed on Aug. 4, 2004.

(51) Int. Cl. G09B 25/00

(52) U.S. Cl. 434/382

(57) ABSTRACT

A bathroom training kit and method includes a first personal hygiene product ergonomically adapted for use by a child. The first personal hygiene product has indicia associated therewith including at least a first iconic image depicting at least one instruction for use of said first product in a first bathroom activity. A second personal hygiene product ergonomically adapted for use by a child is provided having indicia associated therewith including at least a first iconic image depicting at least one instruction for use of said second product in a second bathroom activity. The first and second bathroom activities comprise separate steps of a personal hygiene regimen, so that a child is instructed in performing a complete hygiene regimen.

### CROSS REFERENCE TO RELATED APPLICATION

This application claims the benefit of U.S. Provisional Application No. 60/598,778 filed on Aug. 4, 2004.

### FIELD OF THE INVENTION

The present disclosure generally relates to personal hygiene products and methods for children, particularly pre-literate children, and, more particularly, to products and methods for instructing such a child to perform a complete personal hygiene regimen.

### BACKGROUND OF THE INVENTION

The teaching and motivation of toddlers and young children is a subject of much attention in patent and general literature. In particular, numerous writings, devices, techniques, aides, and kits have been proposed to assist children, parents (or other caregivers), or both, with personal hygiene tasks. A common challenge for a caregiver is to teach the child to perform a complete personal hygiene task, particularly where the task requires several steps. While assisting in a personal hygiene task, a caregiver not only performs the task but also instructs the child on how to complete the task. The age at which a child will begin bathing on his or her own is dependent upon many factors, some of which are psychological, some physiological, and some unique to each individual child. Typically, this will be prior to the child learning to read.

This presents a unique problem as, unlike adults, children beginning to perform personal hygiene tasks by themselves are typically unable to read the instructions on the personal care products. This means constant intervention by the caregiver instructing the child in how and where to use any particular personal care product. A change in personal care product to one with which a child is unfamiliar requires additional instruction and could possibly lead to regression back to where the caregiver alone is completing the task. This inability of the child to read the instructions can lead to many problems. One such problem is incorrect use of the product, for example, the child using bar soap to wash their hair or washing their body with shampoo, etc. Another problem is a child using too much product.

Additionally, without constant supervision, the child in question may simply fail to adequately or completely perform the personal hygiene task. When bathing, for example, it is not unforeseeable that a child may fail to wash their hair, clean behind their ears, or the like, even though they have been specifically instructed to. This failure to clean thoroughly means that the caregiver needs to, in effect, wash the child again just to be sure the child is clean, even though the child may have washed a substantial portion of his or her body. Furthermore, a child may, at this age, desire privacy and independence. This may be indicated when the child closes a bathroom door, when in the past an open door was never a concern. If the caregiver needs to assist the child, there can be a conflict of emotion for the child that may be obstructive to the development of personal hygiene habits.

These difficulties are exacerbated when the particular personal hygiene task requires use of more than one product. For toilet training, for example, a child must learn the steps of using the commode, wiping, flushing, washing his or her hands, and drying. Many products are known to facilitate a child's execution of these steps. For the step of wiping the perianal area, for example, pre-moistened, flushable, child toilet wipes are known that are easier for a child to use than standard toilet paper. For the step of hand washing, liquid soaps may be provided in a dispenser particularly targeted toward use by children. While these products may include instructions for performing the specific step associated therewith, they do not provide instruction for using a product required in either a previous or subsequent step. In addition, such instructions are frequently provided in a manner that a child cannot readily comprehend. Accordingly, the child may forget to execute one or more steps of the complete hygiene regimen, and his development of personal hygiene skills may be hindered.

### BRIEF DESCRIPTION OF THE DRAWINGS

FIGS. 1A and 1B are perspective views of outer packaging for holding two different personal hygiene products adapted for use by children, which form a kit;

FIG. 2 is a perspective view of a first personal hygiene product adapted for use by children having a label carrying indicia for prompting a child to perform a bathroom activity with the first product;

FIG. 3 is a perspective view of a second personal hygiene product adapted for use by children having a label carrying indicia for prompting a child to perform a bathroom activity with the second product;

FIG. 4 is a series of iconic images for prompting a child to perform bathroom activities related to using the toilet;

FIG. 5 is a series of iconic images for prompting a child to perform bathroom activities related to cleaning hands away from home;

FIG. 6 is a series of iconic images for prompting a child to perform bathroom activities related to bathing;

FIG. 7 is a series of iconic images for prompting a child to perform bathroom activities related to oral hygiene;

FIG. 8 is a series of iconic images for prompting a child to perform bathroom activities related to hair care.

### DETAILED DESCRIPTION

The articles and methods disclosed herein provide instructions for using personal hygiene products that are understandable by a pre-literate child. The instructions direct a child to execute bathroom activities related to a personal hygiene regimen using multiple personal hygiene products.

As used herein, the terms “pre-literate” and “incapable of reading” are used interchangeably to mean the inability of a child to correctly understand, comprehend and follow prompts written in a language that the child can speak without assistance of a caregiver. The ability of a child to recognize letters and/or read one or two isolated words still means that the child is “incapable of reading” since he or she is unable to understand, comprehend and follow such written prompts, without assistance. However, this definition of “incapable of reading” does not exclude the child from being able to understand, comprehend and follow visual prompts which are presented in the form of drawings, icons, symbols, gestures, cartoons and the like.

As used herein, the term “personal hygiene product” includes any product for performing a hygiene task. The product may be used for wiping after toilet use, for cleansing hands, body, and/or hair, for styling hair, for oral care, or for other hygiene practices. The product may further be in the form of a liquid, solid, gas, or combination thereof, and may include an applicator in addition to the product.

As used herein, the term “bathroom activity” is defined herein to refer to a personal hygiene activity which typically takes place in a bathroom or lavatory. Examples of “bathroom activities” include bathing (with sub-activities of body washing, hair washing, drying, dressing, etc.), brushing teeth (with sub-activities of wetting brush, applying toothpaste to brush, brushing, rinsing, and clean-up of equipment), hair styling (with sub-activities of washing hair, rinsing hair, applying conditioner, and styling hair), away from home or travel cleaning (with sub-activities of using hand wipes and applying sanitizer), and toilet use (with sub-activities of entering the lavatory or bathroom, removing clothing, sitting on the commode, voiding, flushing, wiping or other clean up, replacing clothing, hand washing, and leaving the lavatory or bathroom).

As used herein, the term “personal hygiene regimen” means two or more bathroom activities that are related to the same personal hygiene task.

As used herein, the term “comprising” means that the various components, ingredients, or steps, can be conjointly employed in practicing the present invention. Accordingly, the term “comprising” is open-ended and encompasses the more restrictive terms “consisting essentially of” and “consisting of.” Other terms may be defined as they are discussed in greater detail herein.

As used herein a “caregiver” means a person other than the child, such as, a parent, babysitter, family member, teacher, day care worker, or other person who is able to provide sufficient assistance to the child to complete a personal hygiene task. For purpose of style and simplicity, the term “parent” will be used in this specification to refer generally to any caregiver and the use of this term is in no way intended to limit the scope of the aides described and claimed.

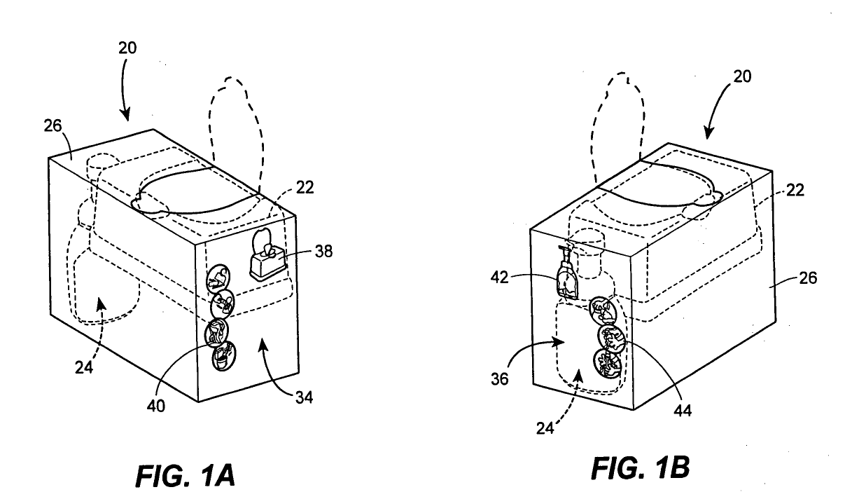

With reference to FIGS. 1A and 1B, an exemplary bathroom training kit 20 is illustrated having a first personal hygiene product 22 and a second personal hygiene product 24. As illustrated, the kit 20 includes packaging 26 for facilitating marketing and purchase of both products together. Such packaging 26, however, is not necessary, and the first and second products 22, 24 need only be associated by their relation to a common personal hygiene regimen.

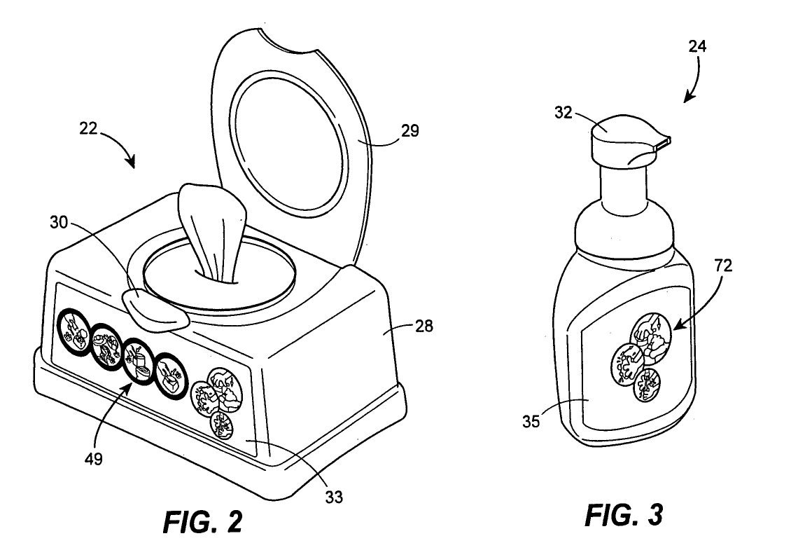

Each of the first and second products 22, 24 is particularly suited for use by a child. The first product 22, which may be disposable wipes stored in a container 28 (FIG. 2), includes a lid 29 or other enclosure that facilitates manipulation by a child. The lid includes a fastening mechanism 30 of a size and shape that is easily grasped by a child. The fastening mechanism 30 further requires an operating force that is well within a normal range of capability for a child. Similarly, the second product 34, which may be a liquid hand soap, where the container therefore includes an oversized dispensing head 32. Accordingly, both products 22, 24 are ergonomically adapted for use by a child. While specific types of products have been illustrated herein, it will be appreciated that other types of products related to other bathroom activities may be used as the first and second personal hygiene products 22, 24 provided in the kit 20.

The packaging 26 may also include a flap 21 that is openable to allow access to at least a portion of an interior of the packaging 26. The flap 21 has a closed position in which it is substantially contiguous with a top panel 23 of the packaging 26, thereby to fully enclose the first and second products 22, 24 within the packaging 26. Scores, perforations, or other separating means may be formed in the packaging 26 to define an outer edge of the flap 21 and to allow the flap to be rotated about a hinge 25 to an open position, illustrated in phantom in FIGS. 1A and 1B. The flap 21 may be located such that when the first product container 28 is positioned inside the packaging 26, the flap 21 in the open position allows access to the container lid 29. Accordingly, the flap 21 enables a consumer to try the fastening mechanism 30 of the container 28 before opening the packaging 26, either prior or subsequent to purchasing the kit 20. Such access prior to purchase may influence a consumer to buy the kit by demonstrating the ease with which a child would be able to open and close the container 28.

The first and second personal hygiene products 22, 24 have associated therewith indicia for prompting a child to perform one or more bathroom activities. As used herein, the phrases “associated therewith” and “in association with” are used interchangeably to mean that the indicia refers to the products. For example, the indicia may be printed directly on the containers for the products 22, 24 or printed on a separate substrate, such as a label, that is affixed to the product containers. FIGS. 2 and 3 illustrate labels 33, 35 affixed to the first and second personal hygiene products 22, 24, respectively. Still further, the indicia may be provided in literature that is provided independently from the products, or included with either or both of the products, whether packaged individually or as a kit. For example, as illustrated in FIGS. 1A and 1B, the outer packaging 26 of the kit 20 includes indicia 34 associated with the first product 22 and indicia 36 associated with the second product 24. The indicia 34 includes a graphical representation 38 of the first product 22 and a series of icons 40 illustrating use of the first product 22. Similarly, the indicia 36 includes a graphical representation 42 of the second product and a series of icons 44 illustrating use of the second product 24. Where applicable, such as with disposable wipes, the indicia may be printed directly on the product itself. As used herein, the term “print” is intended to broadly cover all forms of forming visible marks on a product, container, label, tag, or other substrate.

The indicia may be in the form of any visual communication suitable for communicating to a pre-literate child how to use the product associated therewith. Accordingly, the indicia may include iconic images, which may comprise, but is not limited to, pictorial symbols, photographs, drawings, cartoons, and logos. For example, the iconic images may be provided as drawings of a child or an anthropomorphic image of an animal performing bathroom activities using the products. Similarly, the iconic images may include well-known cartoon characters or brand logos, or characters specifically created to be associated with the products. The iconic images may further include symbols, such as arrows, to indicate motion or movement.

The indicia may be arranged in any manner as long as it communicates to a pre-literate child how to use the associated product. Depending on the product and/or the number of steps needed to perform a bathroom activity, the indicia for each product may be a single iconic image or a series of iconic images. Each iconic image may include one or more visual prompts. Where a series of iconic images are provided, the images may be arranged in any suitable fashion, such as, but not limited to, vertically, horizontally, diagonally, circular, and combination thereof.

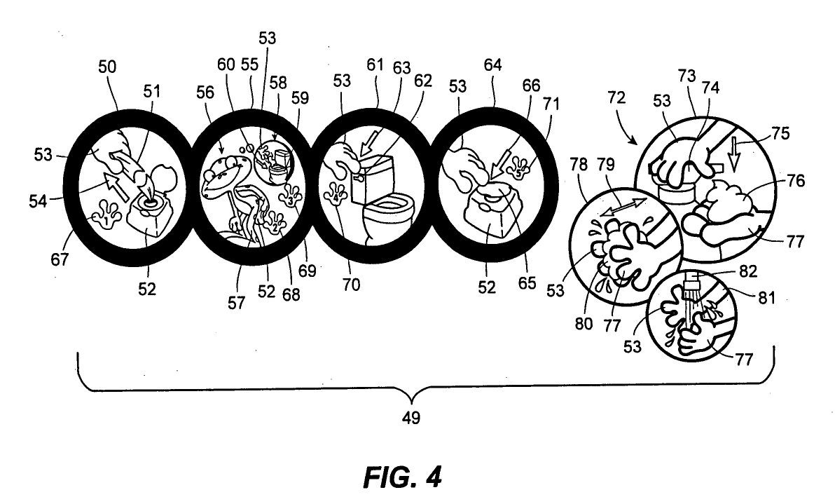

The indicia may include iconic images that present a story line in which a character, such as the frog of FIGS. 4-8, is illustrated performing an activity which will lead to the character needing to perform a bathroom activity, such as to bathe. Illustrative, but non-limiting, examples of such activities include running, riding, playing in the mud, playing with a ball, playing hide and seek, or other similar activities to which a child who is unable to read does and can relate. In this way, the indicia may permit a caregiver to interact with the child regarding the story line created by the indicia and may provide an opportunity for the caregiver to teach the child important lessons regarding performing bathroom activities and complete personal hygiene regimens.

The indicia may optionally include a character graphic that can increase a child's interest in using the product and can increase the opportunities for the caregiver to interact positively with the child. The term “character graphic” is used herein to refer to a graphic containing an anthropomorphic image, and in particular an image having or suggesting human form or appearance which ascribes human motivations, characteristics or behavior to inanimate objects, animals, natural phenomena, toys, cartoon characters, or the like. Ideally the character graphic would be suitable for children's swimwear, toys, clothing, diapers or the like and could be utilized to motivate children to use the article of commerce. To that end, the character graphic may be associated with popular characters in the media, advertising or well known in a particular culture. Ideally they are characters that the child or caregiver care about and want to identify with. Ideally the child can imagine taking the place of the character or emulating the character's behavior/attitude.

The character graphics may encourage and motivate a child to perform bathroom activities, such as cleaning themselves or other personal care. The character graphic may provide a source of entertainment and reassurance for the child and a buddy, or friend, who reduces stress and can be related to in a non-competitive fashion during the training period. The character may also provide positive reinforcement and encouragement to the child while the child is learning new skills and behaviors to clean themselves in a non-competitive or threatening manner.

Suitable character graphics can include animals, people, inanimate objects, natural phenomena, cartoon characters or the like, that may or may not be provided with human features such as arms, legs, facial features or the like. It may be desirable for the character graphic to be familiar to the child, such as an identifiable cartoon character. The character graphics should at least be a type that the child can relate to, examples of which could include animals, toys, licensed characters, or the like. Character graphics can be made more personable and friendly to the child by including human-like features, human-like expressions, apparel, abilities, or the like. In one optional embodiment it is desirable for a character to have a distinguishing feature or features, which in a pictograph can help in training, such as a frogs webbed hand. By way of illustration, an animal character graphic can be shown smiling, wearing clothing, playing sports, fishing, driving, playing with toys, or the like. In particular embodiments, the character graphic can desirably be created to project an appearance that could be described as friendly, positive, non-intimidating, silly, independent, inspirational, active, expressive, dauntless and/or persevering. For example, the frog of FIGS. 4-8 is one example of such a character graphic and is intended to inspire the child to learn how to bathe and clean themselves. The frog's expression clearly shows that while he is concentrating on cleaning himself and becoming independent, he is still smiling and having fun. Additionally, it is preferred that the characters expressions are exaggerated so as to not be too subtle for a child to understand. Furthermore the combination of story line graphics and character graphics are believed to make children more interested in the bathroom activity and therefore lead to enhanced results.

In one optional embodiment the indicia may optionally include a character graphic which is associated with a line of children's consumer products, especially personal cleansing products and the like. The character may be one of a family, group, team, or the like, each member of which is designed to be associated with, for example, a consumer product, a bathroom activity such as washing hair, an age group, stage of infant development and the like. Alternatively, all of the characters of a family, group, team, or the like, may be designed to be associated with the entire range of consumer products.

The association by the child of the character with the consumer product, bathroom activity etc., encourages and provides a way for the child to visualize through their imagination the character using the consumer product in the way intended. Furthermore, since this teaching is through the use of the child's imagination, there are none of the negative connotations associated with conventional parental instruction on how to use a consumer product. Instead of the child being subjected to parental nagging to do something the child really doesn't want to do, the child will actively use the consumer product as part of active learning play to interact with their new buddy, or friend, and imitate behavior. The interaction between the child and the character is only limited by the bounds of the child's imagination. The role of the caregiver or parent in then becomes one of actively encouraging imaginative play by the child with the character to use the consumer product correctly, instead of a being perceived by the child as a parent who stops play. Play is actively encouraged and new skills become part of play; “uninterrupted play”. Since the use of the product is essentially play, the child is eager to use the article of commerce and learn the skill.

A family or group of character graphics can be used to progress a child through a system of consumer products, especially personal cleansing products and the like. In this embodiment each character of the family or group, would be tailored to appeal to different groups of children. These groups may be based on age, development stages, regions, etc. Alternatively, a single character may be tailored for one particular group consumer products of line of consumer products which are different for children at different ages, development stages, etc. In this case the character may, for example, be of a different age depending on the consumer product and by which group of children the product is intended to be used.

Indicia 49 illustrating how to perform a toilet regimen is shown in FIG. 4. Included in the toilet regimen are the bathroom activities of toilet use and hand washing. Accordingly, the indicia 49 include a first iconic image 50 showing how a toilet wipe 51 is removed from a container 52 of disposable, pre-moistened toilet wipes. A hand 53 is shown grasping the toilet wipe 52, and an arrow 54 illustrates the direction in which the toilet wipe 52 is to be pulled to remove it from the container 52. A second iconic image 55 includes two visual prompts: a first visual prompt 56 illustrating an anthropomorphic animal, in this case a frog 57, wiping a perianal area with the toilet wipe 52, and a second visual prompt 58 showing the hand 53 of the frog 57 disposing of the toilet wipe 52 in a toilet 59. An arrow 60 is provided in the second visual prompt to show the direction in which to dispose of the toilet wipe 52 into the toilet 59. A third iconic image 61 illustrates a flushing step by showing the hand 53 of the frog 57 engaging a toilet flusher 62 and an arrow 63 illustrating the direction in which to push on the flusher 62. A fourth iconic image 64 illustrates closing of the wipe container 52 by showing the frog hand 53 engaging a container flap 65 and applying a force in the direction of arrow 66.

A pre-literate child may be capable of identifying and understanding numbers, and therefore the indicia 49 may include numerical graphical representations to identify the order in which to perform the steps of the hygiene regimen. As illustrated in FIG. 4, the first iconic image 50 includes graphical representation 67 which indicates that it is the first step. The second iconic image 55 includes graphical representations 68, 69 indicating that wiping and discarding are the second and third steps, respectively. The third iconic image 61 includes a graphical representation 70 indicating that flushing is the fourth step, while the fourth iconic image 64 includes a graphical representation 71 indicating that closing the wipe container is a fifth step.

The indicia 49 may further include a fifth iconic image 72 that illustrates use of the second hygiene product in the hygiene regimen. For example, the fifth iconic image 72 may show hand washing with liquid soap by illustrating three steps. The fifth iconic image 72 may include a first graphical representation 73 showing the hand 53 of the frog 57 applying pressure to a soap dispenser head 74 in a direction of an arrow 75 to dispense soap 76 into the other hand 77 of the frog. A second graphical representation 78 shows the frog scrubbing its hands 53, 77 together in the direction of double-ended arrow 79 to create lather 80, while a third graphical representation 81 shows rinsing by positioning the hands 53, 77 under a running faucet 82.

From the foregoing, therefore, the first four iconic images (i.e., iconic images 50, 55, 61, and 64) illustrate steps associated with the bathroom activity of toilet use, while the fifth iconic image 72 illustrates the bathroom activity of hand washing. By providing the iconic images 50, 55, 61, 64, and 72 together as a series, it will be appreciated that the indicia provides instructions for using two different products (i.e., a toilet wipe and liquid hand soap) to perform a complete toilet regimen.

As illustrated in FIG. 2, the indicia 49 may be included on the container 28 holding the first personal hygiene product 22. Furthermore, only a portion of the indicia 49, such as the fifth iconic image 72, may be provided on the container holding the second personal hygiene product 24 (FIG. 3). As an alternative, or in addition, to the containers for the products, the entire indicia 49 or portions thereof may be provided on the package 26 for the kit 20. As shown in FIGS. 1A and 1B, the icons 40, 44 provided on the package 26 may include one or more iconic images 50, 55, 61, 64, or 72.

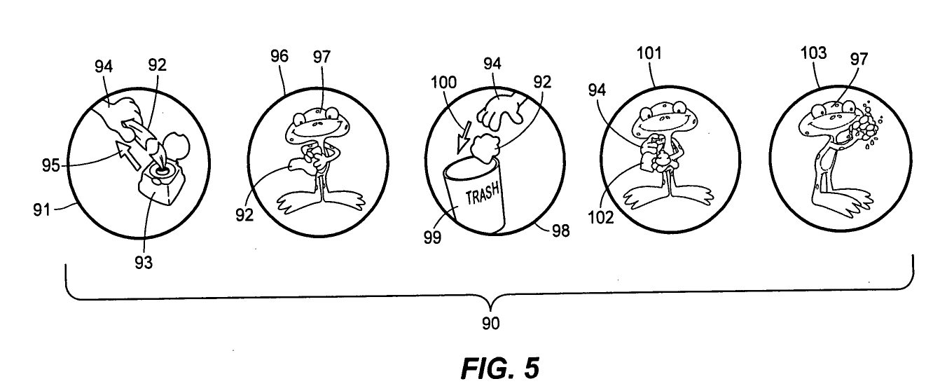

Indicia 90 illustrating how to perform a travel cleaning regimen is illustrated in FIG. 5. The exemplary travel cleaning regimen includes the bathroom activities of washing hands with a wipe and applying a sanitizer, which may be required away from home when a water faucet is unavailable. Accordingly, the indicia 90 includes a first iconic image 91 illustrating how a hand wipe 92 is removed from a container 93 of hand wipes by showing a hand 94 grasping the hand wipe 92, and an arrow 95 illustrating the direction in which the hand wipe 92 is to be pulled to remove it from the container 93. A second iconic image 96 illustrates use of the hand wipe 92 by showing a frog 97 rubbing its hands with the wipe 92. A third iconic image 98 illustrates disposal of the hand wipe 92 by showing the hand 94 depositing the wipe in a waste receptacle 99 and an arrow 100 showing the direction in which the hand wipe is deposited. A fourth iconic image 101 illustrates dispensing of a hand sanitizer from a dispenser 102 by showing the hand 94 operating the dispenser 102 to discharge sanitizer. A fifth iconic image 103 illustrates use of the sanitizer by showing the frog 97 rubbing its hands with the sanitizer. From the foregoing, therefore, the first three iconic images (i.e., iconic images 91, 96, and 98) illustrate steps associated with the bathroom activity of washing hands with a wipe, while the last two iconic images (i.e., iconic images 101 and 103) illustrate the steps associated with the bathroom activity of hand sanitizing. By providing the iconic images as a series, it will be appreciated that the indicia provides instructions for using two different products (i.e., a hand wipe and a hand sanitizer) to perform a complete travel regimen.

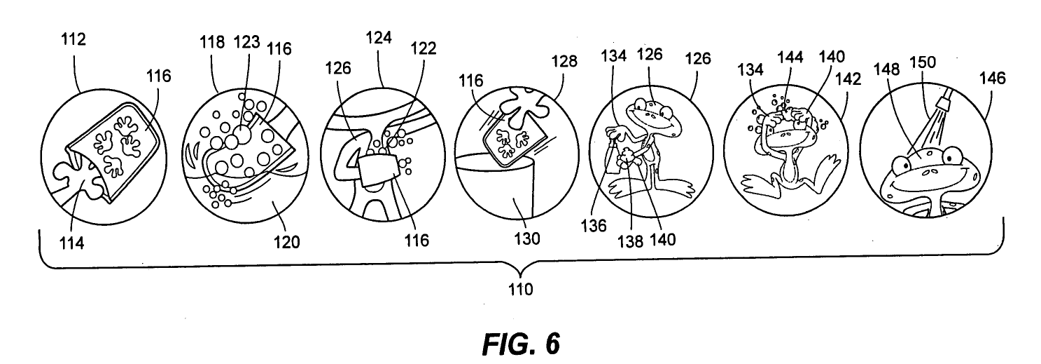

Indicia 110 illustrating how to perform a bathing regimen is illustrated in FIG. 6. The exemplary bathing regimen includes the bathroom activities of body washing with a child's cleansing mitt and shampooing with a liquid shampoo. Accordingly, the indicia 110 includes a first iconic image 110 illustrating where a child is to place her hand to wear the mitt and the correct orientation of the cleansing mitt relative to the child, by showing a hand 114 being inserted into an open end of a mitt 116. A second iconic image 118 illustrates how to generate lather on the cleansing mitt by showing the mitt 116 partially submerged under water 120 to create foam 122. A third iconic image 124 illustrates use of the cleansing mitt by showing the mitt 116 applied against a torso of a frog 126 to spread the foam 122. A fourth iconic image 128 illustrates disposal of the cleansing mitt 116 into a waste receptacle 130. A fifth iconic image 132 illustrates dispensing of shampoo from a shampoo dispenser by showing a hand 134 of the frog 126 squeezing a shampoo dispenser head 136 so that shampoo 138 is discharged into the other hand 140 of the frog. A sixth iconic image 142 illustrates application of the shampoo to a child's hair by showing the frog's hands 134, 140 applying shampoo 144 to the frog's head to create lather. A seventh iconic image 146 illustrates rinsing shampoo from a child's hair by showing the frog's head 148 positioned under a stream of water 150. From the foregoing, therefore, the first four iconic images (i.e., iconic images 112, 118, 124, and 128) illustrate steps associated with the bathroom activity of body washing with soap, while the last three iconic images (i.e., iconic images 132, 142, and 146) illustrate the bathroom activity of cleaning hair with shampoo. By providing the iconic images as a series, it will be appreciated that the indicia provides instructions for using two different products (i.e., a body soap and a shampoo) to perform a complete bathing regimen.

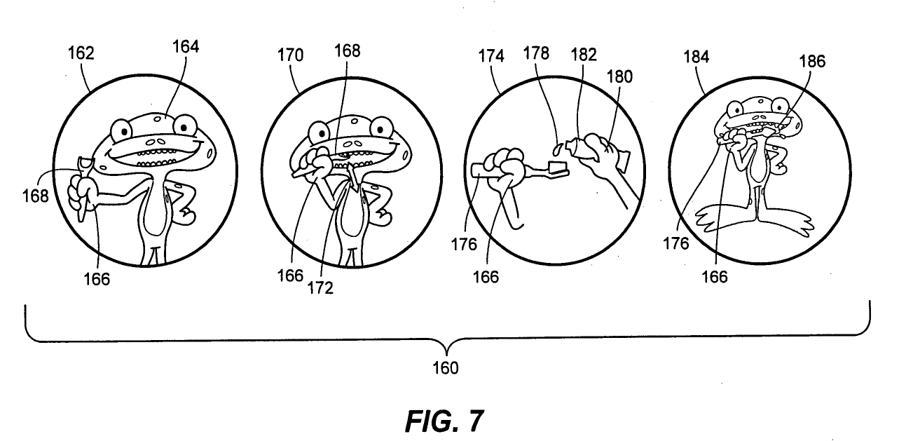

Indicia 160 illustrating how to perform an oral care regimen is illustrated in FIG. 7. The exemplary oral care regimen includes the bathroom activities of flossing with a dental floss and brushing teeth with toothpaste. Accordingly, the indicia includes a first iconic image 162 illustrating how to hold a floss holder by showing a frog 164 with a first hand 166 holding a floss holder 168. A second iconic image 170 illustrates how to clean between teeth by showing the first hand 166 holding the floss holder 168 in an orientation such that the floss is inserted between adjacent teeth and reciprocated in the directions of double-ended arrow 172. A third iconic image 174 illustrates loading a tooth brush 176 with toothpaste 178 by showing the first hand 166 holding the tooth brush 176 and the second hand 180 squeezing a container of toothpaste 182, so that toothpaste 178 is discharged from the container onto the tooth brush. A fourth iconic image 184 illustrates brushing teeth with the toothpaste by illustrating the first hand 166 holding the tooth brush 176 in an orientation such that a head of the brush engages the teeth to generate foam 186. Additional iconic images may show other steps, such as rinsing toothpaste residue from the mouth. From the foregoing, therefore, the first two iconic images (i.e., iconic images 162 and 170) illustrate steps associated with the bathroom activity of flossing with dental floss, while the last two iconic images (i.e., iconic images 174 and 184) illustrate the bathroom activity of brushing teeth with toothpaste. By providing the iconic images as a series, it will be appreciated that the indicia provides instructions for using two different products (i.e., dental floss and toothpaste) to perform a complete oral care regimen.

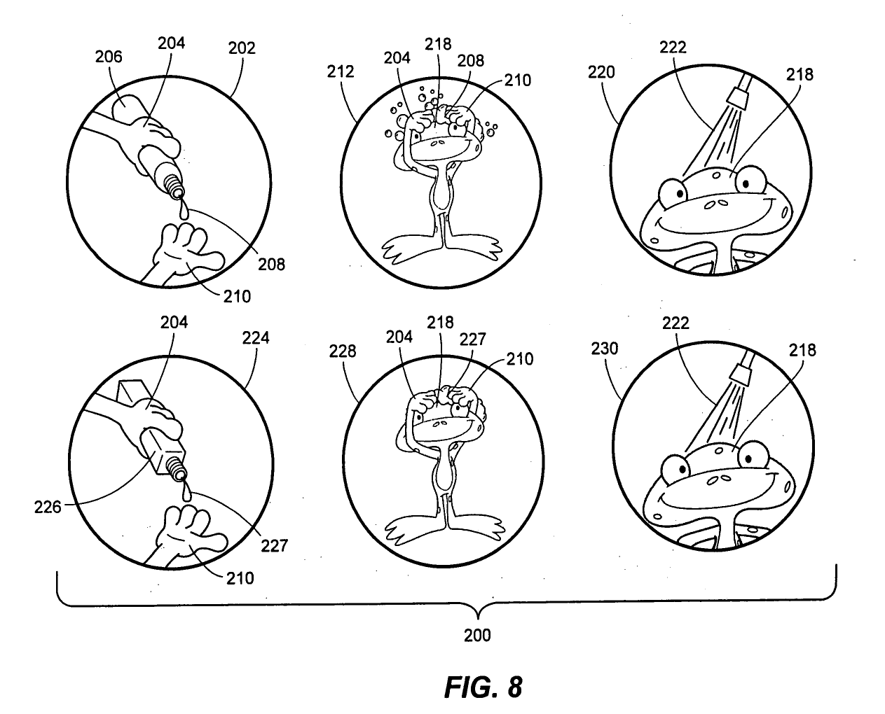

Indicia 200 illustrating how to perform a hair care regimen is illustrated in FIG. 8. The exemplary hair care regimen includes the bathroom activities of cleaning hair with shampoo and application of a conditioner. Accordingly, the indicia includes a first iconic image 202 illustrating dispensing of shampoo from a shampoo dispenser by showing a hand 204 squeezing the dispenser 206 inwardly to discharge shampoo 208 into the other hand 210 of the frog. A second iconic image 212 illustrates application of the shampoo to a child's head by showing the frog's hands 204, 210 applying the shampoo 208 to the frog's head 218 to create lather. A third iconic image 220 illustrates rinsing shampoo from a child's hair by showing the frog's head 218 positioned under a stream of water 222. A fourth iconic image 224 illustrates dispensing of conditioner from a dispenser by showing the hand 204 of the frog squeezing the dispenser 226 inwardly to discharge conditioner 227 into the other hand 210. A fifth iconic image 228 illustrates applying conditioner to a child's hair by showing the frog hands 204, 210 engaging the head 218 to spread conditioner 227. A sixth iconic image 230 illustrates rinsing conditioner from the child's hair by showing the frog's head 218 positioned under a stream of water 222. From the foregoing, therefore, the first three iconic images (i.e., iconic images 202, 212, and 220) illustrate steps associated with the bathroom activity of cleaning hair with a shampoo, while the last three iconic images (i.e., iconic images 224, 228, and 230) illustrate the bathroom activity of hair styling with a conditioner. By providing the iconic images as a series, it will be appreciated that the indicia provides instructions for using two different products (i.e., shampoo and conditioner) to perform a complete hair styling regimen.

The specific examples of personal hygiene regimens are presented above are not intended to be limiting, as variations of the described regimens and other types of regimens are known. Furthermore, this disclosure is not limited to the particular steps for each disclosed personal hygiene regimen or the specific iconic images illustrating these steps, as the foregoing are merely exemplary embodiments.

In one alternative embodiment, first and second products 22, 24 may be further provided with common design features that encourage the child to complete all of the tasks associated with the personal hygiene regimen. Such design features could include, but are not limited to, common color schemes for first and second products 22, 24; common package shapes (e. g. soft, flowing curvature) and other similar common features. Such common design features enable the child to identify all of the packages that may be associated with the cleaning regimen so he or she is more likely to complete all of the tasks. The commonality of features also helps reassure a caregiver that all of the tasks have been completed.

Also disclosed herein is a method of instructing a pre-literate child to perform a personal hygiene regimen requiring at least first and second bathroom activities. The method uses the above disclosed iconic images to illustrate to the child how to use personal hygiene products needed to complete the personal hygiene regimen. The method may include, for example, associating a first personal hygiene product adapted for use by a child with at least a first iconic image depicting at least one instruction for use of the first product in the first bathroom activity. Further, a second personal hygiene product adapted for use by a child may be associated with at least a first iconic image depicting at least one instruction for use of the second product in the second bathroom activity. Furthermore, the first and second iconic images may be juxtaposed such that a child may follow the steps illustrated thereby. For example, the images may be provided on containers holding the first and second products, and the container may be placed adjacent one another, such as by common packaging, to place the iconic images in sufficient proximity with one another. Alternatively, one or both of the product containers may include a cross-reference to the other product container, such as by carrying the iconic images associated with both products on a single label.

All documents cited in the Detailed Description are, in relevant part, incorporated herein by reference; the citation of any document is not to be construed as an admission that it is prior art with respect to the present disclosure.

While particular embodiments of the present disclosure have been illustrated and described, it would be obvious to those skilled in the art that various other changes and modifications can be made without departing from the spirit and scope of the invention. It is therefore intended to cover in the appended claims all such changes and modifications that are within the scope of this disclosure.

What is claimed is:

1. A bathroom training kit comprising:
a first personal hygiene product ergonomically adapted for use by a child, the first personal hygiene product having indicia associated therewith including at least a first iconic image depicting at least one instruction for use of said first product in a first bathroom activity; and
a second personal hygiene product ergonomically adapted for use by a child, the second personal hygiene product having indicia associated therewith including at least a first iconic image depicting at least one instruction for use of said second product in a second bathroom activity;
wherein the first and second bathroom activities comprise separate steps of a personal hygiene regimen.

2. The bathroom training kit of claim 1, in which the first personal hygiene product indicia further includes a second iconic image depicting at least one instruction for use of said second product in the second bathroom activity.

3. The bathroom training kit of claim 1, in which the personal hygiene regimen comprises a toilet regimen, the first bathroom activity comprises wiping, and the second bathroom activity comprises hand washing, wherein:
the first personal hygiene product comprises at least one child toilet wipe and the first iconic image associated with the first personal hygiene product depicts at least one instruction for wiping a perianal area with a toilet wipe; and
the second personal hygiene product comprises liquid hand soap and the first iconic image associated with the second personal hygiene product depicts at least one instruction for hand washing with the liquid hand soap.

4. The bathroom training kit of claim 3, in which the at least one child toilet wipe is stored in a container and the liquid hand soap is stored in a dispenser, wherein the container and dispenser are associated in an outer package.

5. The bathroom training kit of claim 1, in which the personal hygiene regimen comprises a travel cleaning regimen, the first bathroom activity comprises hand washing, and the second bathroom activity comprises hand sanitizing, wherein:
the first personal hygiene product comprises at least one hand wipe and the first iconic image associated with the first personal hygiene product depicts at least one instruction for hand wiping with a hand wipe; and
the second personal hygiene product comprises a sanitizer and the first iconic image associated with the second personal hygiene product depicts at least one instruction for hand sanitizing with the sanitizer.

6. The bathroom training kit of claim 1, in which the personal hygiene regimen comprises a bathing regimen, the first bathroom activity comprises body washing, and the second bathroom activity comprises hair shampooing, wherein:
the first personal hygiene product comprises a body cleaning product and the first iconic image associated with the first personal hygiene product depicts at least one instruction for body washing with the body cleaning product; and
the second personal hygiene product comprises a shampoo and the first iconic image associated with the second personal hygiene product depicts at least one instruction for hair washing with the shampoo.

7. The bathroom training kit of claim 6, in which the body cleaning product is provided in the form of a mitt adapted to fit on a child's hand.

8. The bathroom training kit of claim 1, in which the personal hygiene regimen comprises an oral care regimen, the first bathroom activity comprises teeth brushing, and the second bathroom activity comprises flossing, wherein:
the first personal hygiene product comprises a flossing product and the first iconic image associated with the first personal hygiene product depicts at least one instruction for flossing with the flossing product; and
the second personal hygiene product comprises a toothpaste and the first iconic image associated with the second personal hygiene product depicts at least one instruction for teeth brushing with the toothpaste.

9. The bathroom training kit of claim 1, in which the personal hygiene regimen comprises a hair care regimen, the first bathroom activity comprises shampooing, and the second bathroom activity comprises hair conditioning, wherein:
the first personal hygiene product comprises a shampoo and the first iconic image associated with the first personal hygiene product depicts at least one instruction for shampooing with the shampoo; and
the second personal hygiene product comprises a hair conditioner and the first iconic image associated with the second personal hygiene product depicts at least one instruction for applying the hair conditioner.

10. The bathroom training kit of claim 1, in which the first bathroom activity comprises at least first and second steps and the first iconic image associated with the first personal hygiene product depicts at least one instruction for using the first product in the first step of the first bathroom activity, the indicia associated with the first personal hygiene product further comprising a second iconic image depicting at least one instruction for using the first product in the second step of the first bathroom activity.

11. The bathroom training kit of claim 1, in which the iconic images associated with the first and second personal hygiene products are of a form capable of being understood and followed by a pre-literate child.

12. The bathroom training kit of claim 1, in which the first personal hygiene product comprises labeling which carries the indicia including the first iconic image, and in which the second personal hygiene product comprises labeling which carries the indicia including the second iconic image.

13. A method of instructing a pre-literate child to perform a personal hygiene regimen requiring at least first and second bathroom activities, the method comprising:
associating a first personal hygiene product adapted for use by a child with at least a first iconic image depicting at least one instruction for use of the first product in the first bathroom activity;
associating a second personal hygiene product adapted for use by a child with at least a first iconic image depicting at least one instruction for use of the second product in the second bathroom activity; and
packaging the first and second personal hygiene products in a common outer package.

14. The method of claim 13, further comprising associating the first personal hygiene product with a second iconic image depicting at least one instruction for use of the second product in the second bathroom activity.

15. The method of claim 13, in which the first bathroom activity comprises at least first and second steps and the first iconic image of the first personal hygiene product depicts at least one instruction for using the first product in the first step of the first bathroom activity, the method further comprising associating the first personal hygiene product with a second iconic image depicting at least one instruction for using the first product in the second step of the first bathroom activity.

16. The method of claim 13, in which the first bathroom activity comprises hand washing, and the second bathroom activity comprises hand sanitizing, wherein:
the first personal hygiene product comprises at least one child toilet wipe and the first iconic image associated with the first personal hygiene product depicts at least one instruction for wiping a perianal area with a toilet wipe; and
the second personal hygiene product comprises liquid hand soap and the first iconic image associated with the second personal hygiene product depicts at least one instruction for hand washing with the liquid hand soap.

17. A bathroom training kit comprising:
a first personal hygiene product ergonomically adapted for use by a child, the first personal hygiene product having a label which carries indicia including at least a first iconic image depicting at least one instruction for use of said first product in a first bathroom activity; and
a second personal hygiene product ergonomically adapted for use by a child, the second personal hygiene product having a label which carries indicia including at least a first iconic image depicting at least one instruction for use of said second product in a second bathroom activity;
wherein the first and second bathroom activities comprise separate steps of a personal hygiene regimen, the first product indicia further includes a second iconic image depicting at least one instruction for using the second product in the second bathroom activity, and the iconic images carried by the first and second personal hygiene products are of a form capable of being understood and followed by a pre-literate child.

18. The bathroom training kit of claim 17, in which the second bathroom activity comprises at least first and second steps and the first iconic image carried by the second personal hygiene product depicts an instruction for using the second product in the first step of the second bathroom activity, the indicia associated with the second personal hygiene product further comprising a second iconic image depicting an instruction for using the second product in the second step of the second bathroom activity.

19. The bathroom training kit of claim 17, in which the personal hygiene regimen comprises a toilet regimen, the first bathroom activity comprises wiping, and the second bathroom activity comprises hand washing, wherein:
the first personal hygiene product comprises at least one child toilet wipe and the first iconic image carried by the first personal hygiene product depicts at least one instruction for wiping a perianal area with a toilet wipe; and
the second personal hygiene product comprises liquid hand soap and the first iconic image carried by the second personal hygiene product depicts at least one instruction for hand washing.

20. The bathroom training regimen of claim 19, in which the at least one child toilet wipe is stored in a container and the liquid hand soap is stored in a dispenser, wherein the container and dispenser are associated in an outer package.
